(19) United States
(12) Patent Application Publication
(10) Pub. No.: US 2008/0290554 A1
(43) Pub. Date: Nov. 27, 2008

(54) Oriented Polymer Fibers and Methods for Fabricating Thereof

(75) Inventors: Benjamin M. Wu, Los Angeles, CA (US); Michael V. Sofroniew, Los Angeles, CA (US); King-Ning Tu, Los Angeles, CA (US); Yuhuan Xu, Los Angeles, CA (US)

Correspondence Address: DLA PIPER US LLP, 4365 EXECUTIVE DRIVE, SUITE 1100, SAN DIEGO, CA, 92121-2133, US

(73) Assignee: THE REGENTS OF THE UNIVERSITY OF CALIFORNIA, Oakland, CA (US)

(21) Appl. No.: 10/593,023

(22) PCT Filed: Mar. 31, 2005
(86) PCT No.: PCT/US2005/010886

§ 371 Date: Aug. 15, 2008

Related U.S. Application Data
(60) Provisional application No. 60/558,462, filed on Mar. 31, 2004.

(51) Int. Cl. B29C 44/56

(52) U.S. Cl. 264/211.12; 425/174.8 E

(57) ABSTRACT

Devices for fabricating oriented polymer fibers, and methods for fabricating thereof by electropulling, are provided.

### CROSS REFERENCE TO RELATED APPLICATIONS

This application claims the benefit of priority under 35 U.S.C. § 119(e) of U.S. Ser. No. 60/558,462 filed Mar. 31, 2004, the entire content of which is incorporated herein by reference.

### BACKGROUND OF THE INVENTION

1. Field of the Invention

The present invention relates generally to the field of fabricating oriented polymers, and more specifically, to fabricating such polymers by electropulling and to devices for carrying such methods.

2. Background Information

Electrospinning, or electrostatic fiber formation, is a method of producing fibers with diameters ranging from 10 nm to 10 fun by accelerating a jet of charged polymer solution within an electric field. Electrospinning is a rapid, simple, and inexpensive method to fabricate high aspect ratio, submicron diameter size fibers with high surface area. Potential applications of such fibers include filtration and composite materials, catalyst support, optical and chemical sensors, drug delivery, and other.

Electrospun conducting polymers have been used to fabricate various materials, including metallic nanotubes, nanowires and field-effect transistors. Electrospun non-woven biodegradable fabrics can be used as adhesion barriers, for wound dressing and tissue engineering.

Typically, during electrospinning, a reservoir of polymer fluid is connected with a large electric potential and fluid is delivered to the tip of a small capillary, and an external electric field is applied. The electrical charge that develops at the fluid's free surface interacts with the external electric field, resulting in the emission of a steady fluid jet that thins as it accelerates towards the collector.

The jet can experience a whipping instability, leading to bending and stretching of the jet, observed as loops of increasing size. The whipping jet can then thins substantially, while traveling the short distance between the electrodes. The presence of polymer in solution leads to the formation of fine solid fibers as the solvent evaporates. The final formation of the fiber mat can be directly influenced by such factors as the driving electrical field, activity of the polymer within the solvent, the viscosity of polymer solution, the evaporation rate of the solvent, and the surface charge of the polymer jet/fiber.

When electrospinning is used, in most cases the final fiber mat that forms on the collector includes polymer fibers having random fiber orientation, including the looping and spiraling path of fibers that can develop due to bending, whipping, and other instabilities that occur during fiber formation. Quasi “oriented fiber mat” has been reported by collecting the electrospun fiber by a “rotating and translating ground target,” but no technique that can produce three dimensionally aligned fibers has been reported.

However, having three dimensionally aligned fibers can be important in such biomedical applications as the regeneration of neural tissues, cardiac tissues, and smooth muscle layers of many organs, to promote cell attachment, alignment, differentiation, and function. Therefore, there exists a need to develop devices and methods that allow fabricating three dimensionally aligned fibers.

### SUMMARY

According to an embodiment of the present invention, a apparatus for fabricating oriented polymer fibers is provided, the apparatus comprising a dispenser for containing an electrically charged polymer dispersion, the dispenser including a proximal end and a distal end, where the proximal end defines an orifice, an electrode positioned near the orifice, wherein the electrode and the orifice define a gap therebetween, and a collector for receiving the oriented polymer fibers, wherein the collector is positioned at a distance from the gap.

According to another embodiment of the present invention, a method for fabricating oriented polymer fibers is provided, the method comprising positioning an electrode near an orifice of a dispenser containing an electrically charged polymer dispersion, to form a gap between the electrode and the orifice, wherein the dispenser has a proximal end and a distal end, and the orifice is defined by the proximal end of the dispenser, electrically pulling the polymer solution from the orifice by electrically charging the electrode; and collecting the oriented polymer fibers at a collector, wherein the collector is positioned at a distance from the gap, to fabricate the oriented polymer fibers.

### BRIEF DESCRIPTION OF THE DRAWINGS

FIG. 1 shows schematically an apparatus for fabricating oriented polymer fibers according to embodiments of the present invention.

FIG. 2 is a microphotograph showing one oriented polymer fiber fabricated according to an embodiment of the present invention.

FIG. 3 is a microphotograph showing another oriented polymer fiber fabricated according to an embodiment of the present invention.

FIG. 4 is a microphotograph showing another oriented polymer fiber fabricated according to an embodiment of the present invention.

### DETAILED DESCRIPTION

### Terms and Definitions

The following terminology, definitions, and abbreviations apply:

The term “polymer” is defined as being inclusive of homopolymers, copolymers, and oligomers. The term “homopolymer” refers to a polymer derived from a single species of monomer. The term “copolymer” refers to a polymer derived from more than one species of monomer, including copolymers that may be obtained by copolymerization of two monomer species, those that may be obtained from three monomers species (“terpolymers”), those that may be obtained from four monomers species (“quaterpolymers”), etc.

The term “copolymer” is further defined as being inclusive of random copolymers, alternating copolymers, graft copolymers, and block copolymers. The term “random copolymer” refers to a copolymer comprising macromolecules in which the probability of finding a given monomeric unit at any given site in the chain is independent of the nature of the adjacent units. In a random copolymer, the sequence distribution of monomeric units typically follows Bernoullian statistics. The term “alternating copolymer” refers to a copolymer comprising macromolecules that may include two species of monomeric units in alternating sequence.

The term “polymer fiber” refers to an elongated stringy material made of a natural polymer or a synthetic polymer. The polymer is refereed to as “oriented” if the axis of main chains of the macromolecules are arrayed predominantly along one direction, and the axis are therefore substantially parallel to each other.

The term “polymer dispersion” is defined as a colloid system comprising a solid polymer disperse phase and a liquid dispersion medium. The solid polymer disperse phase may contain one or a plurality of polymers; the liquid dispersion medium may contain one or a plurality of liquids.

The term “metastable polymer dispersion” refers to a polymer dispersion that is capable to exist for an indefinite period of time as a single phase that is separated by a small or zero energy barrier from a thermodynamically more stable multiphase system. The term “electrically charged polymer dispersion” refers to a polymer dispersion that carries either positive or a negative charge that is derived from a source of electric potential.

The term “surfactant” refers to a surface active soluble compound that can increase stability of a polymer dispersion by reducing the interfacial surface tension between a solid polymer disperse phase and a liquid dispersion medium. The term “biologically active molecule” refers to synthetic or natural compounds and/or substances that can produce a beneficial therapeutic result when administered to a patient in need of such treatment.

The term “poly(vinylidene fluoride-co-trifluoroethylene)” or “PVDF-TFE” refers to a copolymer of vinylidene fluoride, CF₂=CH₂, and trifluoroethylene, CF₂═CHF, and is inclusive of random, alternating, block, and graft copolymers formed by copolymerization of vinylidene fluoride and trifluoroethylene. One example of poly(vinylidene fluoride-co-trifluoroethylene) can be illustrated by the structure (I) in which the units derived from vinylidene fluoride and trifluoroethylene are arranged along the macromolecular chain in the alternating order:

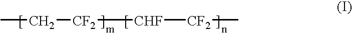

The term “poly(lactic acid-co-glycolic acid)” or “PLGA” refers to a copolymer formed by co-polycondensation of lactic acid, HO—CH(CH₃>COOH, and glycolic acid, HO-CH₂COOH, the copolymer having the structure (II):

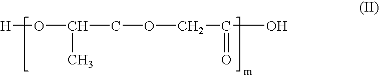

### EMBODIMENTS OF THE INVENTION

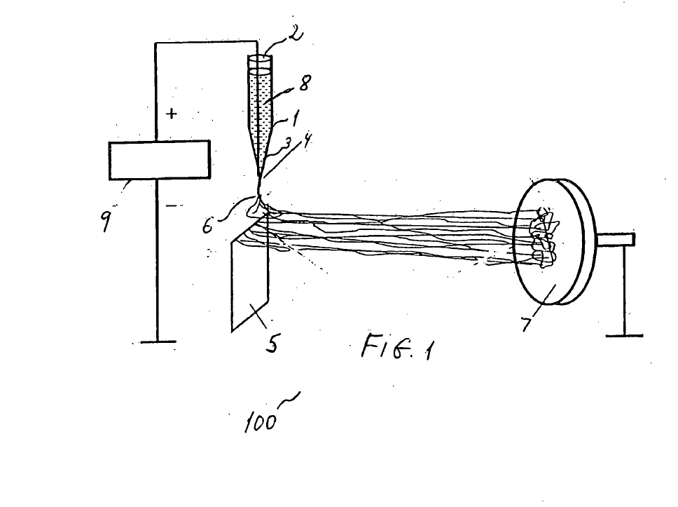

An apparatus 100 for fabricating oriented polymer fibers according to an embodiment of the present invention is shown schematically on FIG. 1. The apparatus 100 includes a dispenser 1 having a distal end 2 and a proximal end 3. The tip of the proximal end 3 can include an orifice 4. The orifice 4 can comprise a capillary having the diameter between about 10 nanometers and 100 micrometers, for example, about 10 micrometers. The dispenser 1 can be fabricated of a variety of materials, to be determined by those having ordinary skill in the art. A representative example of the material that can be used to make the dispenser 1 includes, but is not limited to, glass.

The apparatus 100 further includes an electrode 5 that can be placed next to the orifice 4 of the dispenser 1, so that a gap 6 can be formed between the orifice 4 and the electrode 5, as shown by FIG. 1. The width of the gap 6 (i.e., the distance between the orifice 4 and the electrode 5) can be between about 1 millimeter and 10 millimeters. The electrode 5 can be fabricated of any material commonly used for making the electrodes, for example, of any suitable metal. The electrode 5 is connected to a source of electric potential (not shown) so as to allow the electrode 5 to be charged. The source of electric potential can be a battery capable of providing the voltage of between about 20 and 40 kilovolts.

The apparatus 100 also includes a collector 7 positioned at a distance from the gap 6, as shown by FIG. 1. This distance can be between about 10 and 30 centimeters, for example, about 15 centimeters. The collector 7 can be fabricated of any suitable material to be selected by those having ordinary skill in the art. The collector 7 is grounded as shown by FIG. 1.

Further with the reference to FIG. 1, the apparatus 100 can be used for manufacturing oriented polymer fibers by electropulling. An embodiment of the method can be described as follows. A metastable polymer dispersion 8 can be placed into the dispenser 1 using the open distal end 2 of the dispenser 1. The polymer dispersion 8 can be prepared using standard techniques known to those having ordinary skill in the art. For example, a disperse phase comprising a solid polymer can be dispersed in the liquid dispersal phase using any standard dispersing method. The mass ratio between the solid disperse phase and the liquid dispersal phase can be between about 1:5 and 1:20, for example, about 1:10.

The disperse polymer phase can include a polymer or a polymer blend comprising a plurality of polymers. Any polymer capable of forming fibers can be used, particularly polar polymers capable of providing fibers with piezoelectricity, pyroelctricity, and ferroelectricity. Examples of such polymers that can be used include poly(vinylidene fluoride-co-trifluoroethylene) (PVDF-TFE) and poly(lactic acid-co-glycolic acid) (PLGA). Those having ordinary skill in the art may select other fiber-forming polymers.

Instead of using a solid polymer, if desired, a polymer solution can be used for dispersal in the liquid dispersal phase. To prepare the polymer solution, the polymer can be dissolved in a solvent. Any suitable solvent can be selected provided the selected solvent is immiscible with the liquid dispersal phase. A blend comprising a plurality of individual polymers can be used for making the polymer solution, so long as each individual solvent in the blend is soluble in the selected solvent. The concentration (mass) of the polymer solution can be between about 5% and 15%, for example, about 10%.

The liquid phase dispersal phase comprises one or a plurality of liquids. Any suitable liquid(s) can be used for making the liquid dispersal phase as known to those having ordinary skill in the art, so long as the liquid(s) used for making the liquid dispersal phase cannot be true solvent(s) for any polymer that is present in the disperse phase.

The liquid dispersal phase can optionally contain various additives, for example, the additives capable of providing better control of solubility, charge, viscosity, surface tension, evaporation, boiling point, refractive index, to influence the final chemical, physical, and biological properties of the resultant fibers. One kind of additives that can be used includes a surfactant, the use of which is intended to facilitate the making of the dispersion. Any commonly used surfactant(s) can be utilized. Standard ratios between the quantities of the liquid dispersal phase and the surfactant can be used.

Another kind of additives that can be used in the liquid dispersal phase include compounds designed to decrease the stability of the metastable dispersion 8. For example, a sodium chloride solution can be used for this purpose. It may be also desirable to be able to increase charge density on the surface of polymeric fibers to produce 3-dimension oriented fiber mats using polymers with little or no polarity. To that end, doping ions, such as multi-valent cations or anions can be added to the polymeric dispersion.

In some embodiments it may be desirable to make the final polymer fiber biologically active. To that end, biologically active molecules can be added to the liquid dispersal phase. When the process of fabricating the polymer fibers is complete, the biologically active molecules are expected to be present in the final polymer fiber. Any biologically active substance can be used as the source of biologically active molecules. For example, laminin can be used as biologically active molecules.

If it is desirable to incorporate the biologically active molecules within the bulk of the fiber, surfactants can help increase the solubility of the biologically active molecules within the polymer liquid phase, particularly when biologically active molecules that are being incorporated into the fiber have low water solubility, such as hydrophobic drugs or steroids, etc.

The metastable polymer dispersion 8 that is made and placed into the dispenser 1 as described above can be electrically charged. A suitable source of electric potential can be used for charging the dispersion, such as a direct current battery capable of providing voltage between about 20 and 40 kilovolts. In one embodiment, a 30 kilovolt direct current source 9, can be connected to the area of dispenser 1 near the orifice 4, as shown by FIG. 1. The metastable polymer dispersion 8 can be charged either positively or negatively, as desired.

After the metastable polymer dispersion 8 has been charged, electric potential can be applied to the electrode 5. The charge that can be applied is opposite to the charge on the polymer dispersion, and the voltage that can be used for charging the electrode 5 can be between about 20 kilovolts and 40 kilovolts, for example, about 30 kilovolts.

As a result of the application of the electric potential to the electrode 5, a portion of the metastable polymer dispersion 8 can be electrically pulled through the orifice 4, to create liquid column motion, followed by the formation of a polymer jet 9. The polymer jet 9 is accelerated in the electric field and is directed toward the grounded collector 7. Under the conditions associated with the presence of high-voltage electric field, the metastable polymer dispersion 8 can rapidly become unstable, leading to phase separation and segregation.

During phase separation, the water layer can form on the outer surface of the jet column. Phase separation and segregation is followed by evaporation of all liquid components, and formation of polymer fiber that can be collected on the collector 7 as a random fiber mat. The polymer fiber that can be collected can be 3-dimensional oriented fiber.

The following examples are intended to illustrate but not limit the invention.

### EXAMPLE 1

### Fabrication of Poly(Vinylidene Fluoride-Co-Trifluoroethylene) Fiber

About 2 g of PVDF-TFE copolymer, having the mass ratio between the units derived from vinylidene fluoride and the units derived from trifluoroethylene of about 65:35, in the form of pellets, was dissolved in about 15 g of methyl ethyl ketone. To dissolve PVDF-TFE, stirring at room temperature for about 24 hours was used, until a clear polymer solution was obtained.

The PVDF-TFE solution was mixed with deionized water in a mass ratio between the polymer solution and water of about 2:1, to obtain a dispersion in which the polymer solution was dispersed in water, the dispersion containing about 33 mass % water. Ultrasonication was used for preparing the dispersion. The duration of the process of ultrasonication was about 4 minutes, where about 2 second long pulses were alternated with about 2 seconds long stops. The PVDF-TFE/water dispersion was then placed in the dispenser 1 as shown on FIG. 1.

Voltage of 27 about kV (direct current) was then applied to the dispersion. The collector 7 (as shown by FIG. 1) was placed at a distance of about 6 inches (˜15 cm) from the electrode 5. The polymer dispersion was electropulled as a result and 3-dimensional oriented PVDF-TFE fiber was formed between the electrode and the collector 7. The length of the fibers was the same as the distance between the electrode 5 and the collector 7, i.e., about 6 inches or 15 cm.

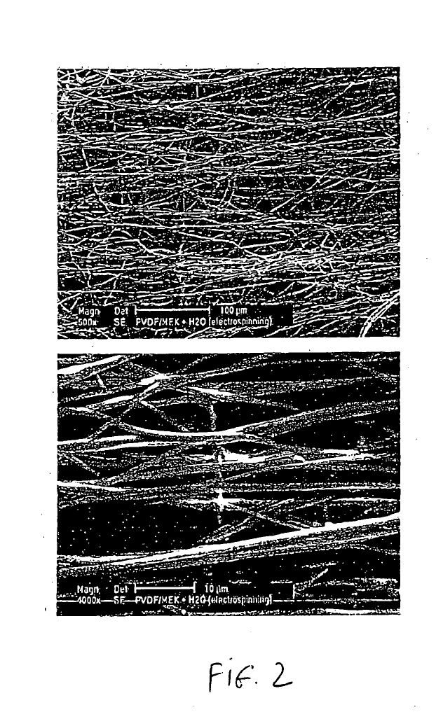

FIG. 2 shows the microphotographic images of the PVDF-TFE fiber formed as a result of the process described above. As can be seen, smooth, oriented, electropulled fibers have been produced.

### EXAMPLE 2

### Fabrication of Poly(L-Glycolic Acid) Fiber

A solution of PLGA in chloroform was mixed with NaCl water solution, to form a water-based polymer dispersion, using the following procedure. About 1.8 g of PLGA was shaken with about 12 g of chloroform at room temperature for about for 24 hours. Then an aqueous solution of sodium chloride was prepared by dissolving about 1.0 g NaCl in about 10 g of deionized water.

The entire 13.8 g of the PLGA/chloroform solution was then mixed with about 4 g of the aqueous sodium chloride solution to form the polymer dispersion. Ultrasonication was used for preparing the dispersion. The duration of the process of ultrasonication was about 4 minutes, where about 2 second long pulses were alternated with about 2 seconds long stops. The resultant PGLA/water dispersion containing sodium chloride was then placed in the dispenser 1 as shown on FIG. 1.

Voltage of 30 about kV (direct current) was then applied to the dispersion. The collector 7 (as shown by FIG. 1) was placed at a distance of about 6 inches (˜15 cm) from the electrode 5. The polymer dispersion was electropulled as a result and 3-dimensional oriented PLGA fiber was formed between the electrode and the collector 7. The length of the fibers was the same as the distance between the electrode 5 and the collector 7, i.e., about 6 inches or 15 cm.

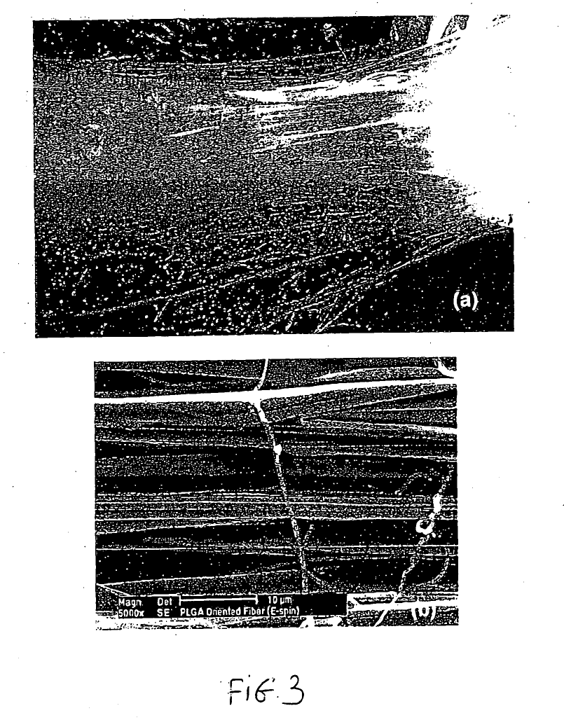

FIG. 3 shows the microphotographic images of the PLGA fiber formed as a result of the process described above. As can be seen, smooth, oriented, electropulled fibers have been produced.

### EXAMPLE 3

### Fabrication of Fibers Incorporating Biologically Active Molecules

A solution of PLGA in chloroform was mixed with NaCl water solution and with the biologically active substance laminin, to form a water-based polymer dispersion incorporating biologically active molecules, using the following procedure.

An aqueous solution of laminin was prepared by dissolving laminin in water to reach the concentration of laminin of about 100 μg/cm³. An aqueous solution of sodium chloride was then prepared by dissolving about 1.0 g sodium chloride in about 10 g of deionized water. About 1 g of the aqueous solution of laminin was mixed with about 3 g of the and the aqueous sodium chloride solution and the mixture was added in to a solution containing about 1.8 g of PLGA dissolved in about 12 g chloroform, to form the polymer dispersion.

Ultrasonication was used for preparing the dispersion. The duration of the process of ultrasonication was about 4 minutes, where about 2 second long pulses were alternated with about 2 seconds long stops, at temperature of about 0° C. The resultant PGLA/water dispersion containing sodium chloride and laminin was then placed in the dispenser 1 as shown on FIG. 1.

Voltage of 30 about kV (direct current) was then applied to the dispersion. The collector 7 (as shown by FIG. 1) was placed at a distance of about 6 inches (−15 cm) from the electrode 5. The polymer dispersion was electropulled as a result and 3-dimensional oriented PLGA fiber was formed between the electrode and the collector 7. The length of the fibers was the same as the distance between the electrode 5 and the collector 7, i.e., about 6 inches or 15 cm.

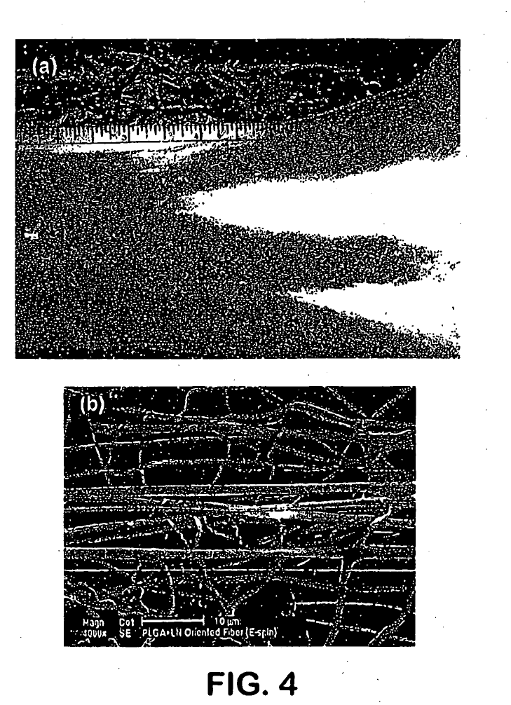

FIG. 4 shows the microphotographic images of the PLGA fiber incorporating laminin formed as a result of the process described above, where laminin, due to the higher solubility in water than in chloroform, is likely to concentrate on the outer surfaces of the fibers. As can be seen, smooth, oriented, electropulled fibers have been produced.

Although the invention has been described with reference to the above example, it will be understood that modifications and variations are encompassed within the spirit and scope of the invention. Accordingly, the invention is limited only by the following claims.

What is claimed is:

1. An apparatus for fabricating oriented polymer fibers, the apparatus comprising:
(a) a dispenser for containing an electrically charged metastable polymer dispersion, the dispenser including a proximal end and a distal end, where the proximal end defines an orifice;
(b) an electrode positioned near the orifice, wherein the electrode and the orifice define a gap therebetween; and
(c) a collector for receiving the oriented polymer fibers, wherein the collector is positioned at a distance from the gap.

2. The apparatus of claim 1, wherein the dispenser is connected to a source of electric potential for charging the polymer dispersion.

3. The apparatus of claim 2, wherein the source of potential is a direct current battery.

4. The apparatus of claim 1, wherein the polymer dispersion comprises a polymer and a liquid phase.

5. The apparatus of claim 4, wherein the polymer is selected from a group consisting of poly(vinylidene fluoride-co-trifluoroethylene) and poly(lactic acid-co-glycolic acid).

6. The apparatus of claim 4, wherein the polymer dispersion further includes doping ions.

7. The apparatus of claim 4, wherein the polymer dispersion further includes a surfactant.

8. The apparatus of claim 4, wherein the polymer dispersion further includes a biological molecule.

9. The apparatus of claim 4, wherein the polymer dispersion further includes a compound decreasing the stability of the metastable polymer dispersion.

10. The apparatus of claim 9, wherein the compound decreasing the stability of the metastable polymer dispersion is sodium chloride.

11. The apparatus of claim 1, wherein the collector is grounded.

12. The apparatus of claim 1, wherein the dispenser is fabricated of glass.

13. The apparatus of claim 1, wherein the orifice is a capillary tip.

14. The apparatus of claim 1, wherein the orifice has a diameter between about 10 nanometers and 100 micrometers.

15. A method for fabricating oriented polymer fibers, the method comprising:
(a) positioning an electrode near an orifice of a dispenser containing a metastable electrically charged polymer dispersion, to form a gap between the electrode and the orifice, wherein the dispenser has a proximal end and a distal end, and the orifice is defined by the proximal end of the dispenser;
(b) electrically pulling the polymer dispersion from the orifice by applying electric voltage to the electrode; and
(c) collecting the oriented polymer fibers at a collector located at a distance from the gap, and allowing the electropulled dispersion to solidify, wherein the collector is positioned at a distance from the gap, to form the oriented polymer fibers.

16. The method of claim 15, wherein the dispenser is connected to a source of electric potential for charging the polymer dispersion.

17. The method of claim 16, wherein the source of electric potential is a direct current battery.

18. The method of claim 15, wherein the metastable polymer dispersion comprises at least one polymer and a liquid phase.

19. The method of claim 18, wherein the liquid phase comprises one or a plurality of liquids.

20. The method of claim 18, wherein the metastable dispersion is fabricated by dispersing a polymer in the liquid phase.

21. The method of claim 18, wherein the metastable dispersion is fabricated by dissolving a polymer in a solvent to make a polymer solution, and dispersing the polymer solution in the liquid phase.

22. The method of claim 18, wherein the polymer is selected from a group consisting of (vinylidene fluoride-co-trifluoroethylene) and poly(lactic acid-co-glycolic acid).

23. The method of claim 18, wherein the metastable dispersion further comprises a compound for decreasing the stability of the metastable polymer dispersion.

24. The apparatus of claim 23, wherein the compound decreasing the stability of the metastable polymer dispersion is sodium chloride.

25. The method of claim 18, wherein the metastable dispersion further comprises biologically active molecules.

26. The method of claim 18, wherein the metastable dispersion further comprises at least one surfactant.

27. The method of claim 15, wherein the collector is grounded.

28. The method of claim 15, wherein the orifice is a capillary tip.

29. The method of claim 15, wherein the orifice has a diameter between about 10 nanometers and 100 micrometers.

30. The method of claim 15, wherein the electric voltage applied to the electrode is between about 20 kV and 40 kV.

31. The method of claim 15, wherein the distance between the gap and the collector is between about 10 centimeters and 30 centimeters.
